(19) United States
(12) Patent Application Publication
(10) Pub. No.: US 2014/0226274 A1
(43) Pub. Date: Aug. 14, 2014

(54) DEVICES AND METHODS FOR OPENING A COMPUTING DEVICE WITH A USER CUE

(71) Applicant: LENOVO (SINGAPORE) PTE. LTD., New Tech Park (SI)

(72) Inventors: Dante Gomez, Yokohama-shi (JP); Eiji Shinohara, Kawasaki-Shi (JP); Hiroki Hirano, Yokohama-shi (JP)

(73) Assignee: LENOVO (SINGAPORE) PTE. LTD., New Tech Park (SI)

(21) Appl. No.: 13/764,988

(22) Filed: Feb. 12, 2013

(51) Int. Cl. G06F 1/16

(52) U.S. Cl. CPC G06F 1/1637
USPC 361/679.27

(57) ABSTRACT

Methods and devices are provided for opening a computing device with a user cue. In one exemplary embodiment, a computing device can include a lid and a base hingedly connected together to allow the computing device to be opened and closed. The computing device can be configured to provide a cue when the lid is opened at or beyond a certain angle with respect to the base. The cue can have a variety of configurations, but in an exemplary embodiment, the cue can be configured to be palpably felt by the user opening the computing device. The cue can include a change in torque force needed to open the lid when the angle between the lid and the base reaches a predetermined threshold angle.

### FIELD OF THE INVENTION

The present invention relates generally to devices and methods for opening a computing device with a user cue.

### BACKGROUND OF THE INVENTION

Current portable computers, e.g., laptop computers, typically include a display and a keyboard. When the computer is in a closed configuration, the display and the keyboard are “hidden” and inaccessible to facilitate portability of the computer and to help protect the display and the keyboard from damage while not in use. The computer can be moved from the closed configuration to an open configuration in which the display and the keyboard are visible and accessible to facilitate use of the computer. To move between the closed and open configurations, a lid including the display can be hingedly connected to a base including the keyboard. The hinged connection can allow the lid and the base to open and close in a “clam shell” manner.

One drawback with current portable computers is that when the base of the computer is resting on a surface such as a tabletop, a desk surface, a user's lap, etc., and when the lid is opened beyond a certain angle with respect to the base, the lid can collide with the tabletop or other surface. FIG. 1 illustrates an example of a base A resting on a surface B with a lid C opened at a first angle with respect to the base A. At the first angle, the lid C does not contact the surface B, as shown within the oval. When the lid C is opened beyond a certain angle greater than the first angle, the lid C will collide with the surface B. FIG. 2 illustrates the lid C opened at a second, larger angle with respect to the base A at which the lid C contacts the surface B, as shown within the burst shape. Although the larger angle is about 180° in the illustrated example, the lid C can collide with the surface B at an angle greater than or less than 180°. The collision can startle a user opening the lid C when the collision suddenly occurs. The lid C colliding with the surface B can cause unpleasant disruption to the user opening the lid C, such as by jarring, shaking, etc. the base A, the lid C, and/or the surface B when the lid C collides with the surface B. If the surface B is a user's lap, can cause the user physical discomfort. Also, the collision of the lid C and the surface B can cause damage to the lid C and/or the surface B, such as scratches, scuffs, dents, and lid logo degradation. The damage can reduce visual appeal of the lid C and/or the surface B, and/or can cause the lid's connection to the base A to become loose. Even one collision can cause any one or more types of damage to the lid C and/or the surface B. Repeated collisions between the lid C and any one or more surfaces can occur as the open angle of the lid C is repeatedly adjusted, which can exacerbate damage over time.

Accordingly, there remains a need for improved devices and methods for opening a computing device.

### SUMMARY OF THE INVENTION

In one embodiment, a device is provided that includes a lid, a base, a display on at least one of the lid and the base, and a processor coupled to at least one of the lid and the base. The processor is configured to cause data to be displayed on the display. The base is movably connected to the lid such that the lid and the base are configured to be positioned relative to one another at an angle up to 180°. A torque force to move the lid and the base relative to one another when the angle is at any positive degree value equal to or greater than a threshold positive degree value is greater than the torque force to move the lid and the base relative to one another when the angle is at any positive degree value less than the threshold positive degree value. In some embodiments, the threshold positive degree value can be about 135°.

The device can vary in any number of ways. For example, the torque force to move the lid and the base relative to one another when the angle is at any positive degree value equal to or greater than the threshold positive degree value can be a uniform torque force. For another example, the torque force to move the lid and the base relative to one another when the angle is at any positive degree value equal to or greater than the threshold positive degree value can be about one and a half times the torque force to move the lid and the base relative to one another when the angle is at any positive degree value less than the threshold positive degree value. For yet another example, the lid and the base can be at the threshold positive degree value relative to one another when the lid and the base are at about 75% of a maximum positive degree value of the angle. For another example, the lid and the base can be configured to be manually positioned relative to one another at the angle by a user, the torque force being configured to be palpably felt by the user during the user's manual positioning of the lid and the base relative to one another so as to allow the user to palpably feel passage of the lid and the base through the threshold positive degree value.

In another embodiment, a device is provided that includes a lid, a base hingedly connected to the lid such that the lid and the base are movable between a closed configuration and a fully open configuration, a display on at least one of the lid and the base, and a processor coupled to at least one of the lid and the base. The processor is configured to cause data to be displayed on the display. The lid and the base are movable at a first uniform torque force between the closed configuration and an intermediate position that is between the fully open configuration and the closed configuration, and the lid and the base are movable at a second uniform torque force between the intermediate position and the fully open configuration. The first uniform torque force is less than the second uniform torque force.

The device can vary in any number of ways. For example, the second uniform torque force can be about one and a half times the first uniform torque force. For another example, the first uniform torque force can be continuously uniform between the closed configuration and the intermediate position, or the first uniform torque force can be uniform for a partial amount of time between the closed configuration and the intermediate position. For yet another example, the intermediate position can be about 75% toward the fully open configuration from the closed configuration. For still another example, an angle between the lid and the base when the lid and the base are in the closed configuration can be about 0°, and the angle between the lid and the base when the lid and the base are in the intermediate position can be about 135°. The angle between the lid and the base when the lid and the base are in the fully open configuration can be about 180°. For another example, the lid and the base can be configured to be manually hingedly moved relative to one another by a user. A change between the first uniform torque force and the second uniform torque force can be configured to be palpably felt by the user during the user's manual movement of the lid and the base relative to one another.

In another aspect, a method is provided that includes providing a computing device including a lid and a base movably connected to the lid such that the lid and the base are configured to be positioned relative to one another at an angle up to 180°. A torque force to move the lid and the base relative to one another when the angle is at any positive degree value greater than a threshold positive degree value is greater than the torque force to move the lid and the base relative to one another when the angle is at any positive degree value less than the threshold positive degree value. In some embodiments, the threshold positive degree value can be about 135°.

The method can have any number of variations. For example, the torque force to move the lid and the base relative to one another when the angle is at any positive degree value greater than the threshold positive degree value can be a uniform torque force. For another example, the torque force to move the lid and the base relative to one another when the angle is at any positive degree value equal to or greater than the threshold positive degree value can be about one and a half times the torque force to move the lid and the base relative to one another when the angle is at any positive degree value less than the threshold positive degree value. For yet another example, the lid and the base can be at the threshold positive degree value relative to one another when the lid and the base are at about 75% of a maximum positive degree value of the angle. For another example, the method can include manually positioning the lid and the base relative to one another at the angle, and passage of the lid and the base through the threshold positive degree value can be palpable as the lid and the base pass through the threshold positive degree value.

### BRIEF DESCRIPTION OF THE DRAWINGS

The invention will be more fully understood from the following detailed description taken in conjunction with the accompanying drawings, in which:

FIG. 1 (PRIOR ART) is a partial side view of a lid and a base of an embodiment of a computing device in a partially open configuration, the base resting on a surface;

FIG. 2 (PRIOR ART) is a partial side view of the lid and the base of FIG. 1 in a fully open configuration with the lid colliding with the surface;

FIG. 3 is a side view of an embodiment of a computing device including a lid and a base, the lid in solid shading showing the lid and the base in a fully open configuration and with the lid in phantom shading showing the lid and the base in a partially open configuration;

FIG. 4 is a schematic diagram of the computing device of FIG. 3;

FIG. 5 is an embodiment of a hinge torque curve versus angle graph;

FIG. 6 is an embodiment of a hinge torque curve versus angle graph for the computing device of FIG. 3;

FIG. 7 is a perspective, partial view of a hinge mechanism hingedly connecting the lid and the base of FIG. 3;

FIG. 8A is a schematic diagram of a rotating washer of the hinge mechanism of FIG. 7;

FIG. 8B is a schematic diagram of the rotating washer of FIG. 8A at a 0° position;

FIG. 8C is a schematic diagram of the rotating washer of FIG. 8A at a 90° position;

FIG. 8D is a schematic diagram of the rotating washer of FIG. 8A at a 135° position;

FIG. 8E is a schematic diagram of the rotating washer of FIG. 8A at a 180° position;

FIG. 9A is a schematic diagram of a friction washer of the hinge mechanism of FIG. 7;

FIG. 9B is a schematic diagram of the friction washer of FIG. 9A at a 0° position;

FIG. 9C is a schematic diagram of the friction washer of FIG. 9A at a 90° position;

FIG. 9D is a schematic diagram of the friction washer of FIG. 9A at a 135° position;

FIG. 9E is a schematic diagram of the friction washer of FIG. 9A at a 180° position;

FIG. 10 is a perspective view of another embodiment of a computing device including a lid and a base, the lid and the base being in a partially open configuration;

FIG. 11 is a partial perspective view of the computing device of FIG. 10;

FIG. 12 is another perspective view of the computing device of FIG. 10;

FIG. 13 is a perspective view of the computing device of FIG. 10, the lid and the base being in a fully open configuration;

FIG. 14 is a side view of another embodiment of a computing device including a lid and a base, the lid and the base being in a partially open configuration;

FIG. 15 is a perspective view of the computing device of FIG. 14;

FIG. 16 is another perspective view of the computing device of FIG. 14; and

FIG. 17 is a perspective view of the computing device of FIG. 14, the lid and the base being in a fully open configuration.

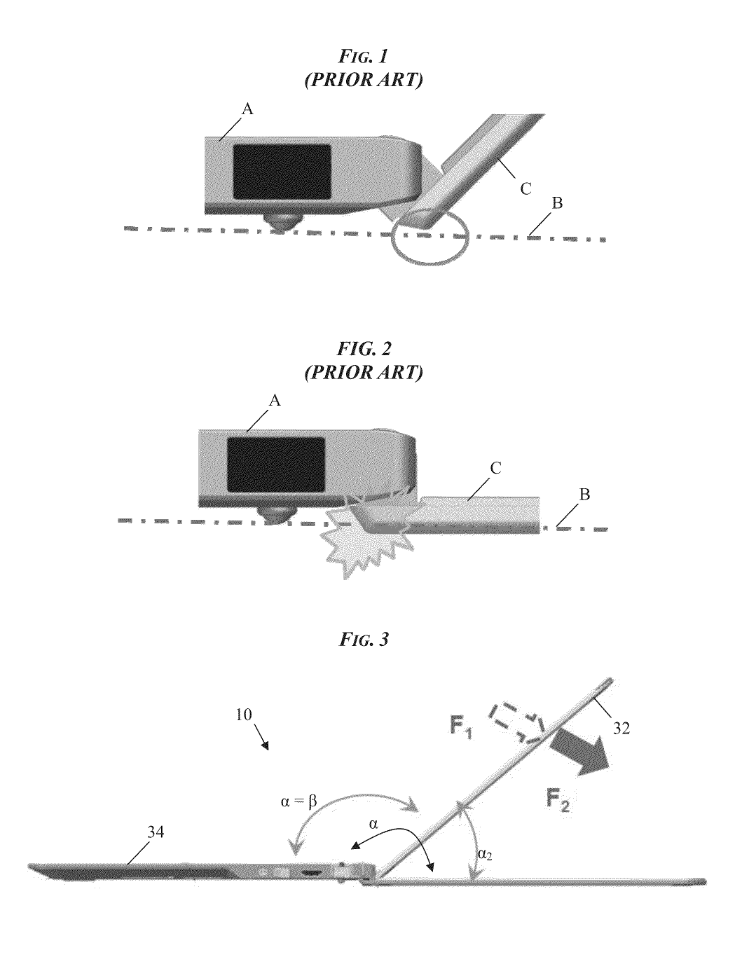

### DETAILED DESCRIPTION OF THE INVENTION

Certain exemplary embodiments will now be described to provide an overall understanding of the principles of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Various exemplary methods and devices are provided for opening a computing device with a user cue. In general, the methods and devices can allow a computing device to provide a cue to a user opening the computing device when the computing device is opened at least a certain amount. The cue can inform the user that a portion of the computing device is close to collision with a surface on which the computing device is resting. The collision can therefore be avoided entirely by the user not opening the computing device any further after receiving the cue, or the collision can be carefully, safely controlled by the user after receiving the cue to minimize disruption to the user and to minimize damage to the computing device and/or the surface. In one embodiment, a computing device can include a lid and a base hingedly connected together to allow the computing device to be opened and closed. The computing device can be configured to provide a cue when the lid is opened at or beyond a certain angle with respect to the base. The cue can have a variety of configurations, but in an exemplary embodiment, the cue can be configured to be palpably felt by the user opening the computing device. The cue can therefore provide silent, non-disruptive notice to the user that the lid is near collision with the surface. The cue can include a change in torque force needed to open the lid when the angle between the lid and the base reaches a predetermined threshold angle. The user can therefore be silently and unobtrusively signaled that the lid is or will soon be at a “safe” maximum angle, thereby silently and unobtrusively encouraging the user to stop opening the lid any further before a collision occurs between the lid and the surface and/or be silently and unobtrusively warning the user that the collision may occur shortly if the lid continues being opened. The change in torque force required to open the lid can therefore help to minimize any negative effects of a collision between the lid and the surface, should the collision even happen after the cue is provided. The lid can include no protective rubber parts, or less protective rubber parts than a traditional lid, because chances of collision can be reduced, thereby reducing manufacturing costs of the device. The torque force to open the lid can be greater when the angle is at or beyond the predetermined threshold angle than the torque force needed to open the lid when the angle is less than the predetermined threshold angle. In other words, more force can be required to open the lid when the lid is at or beyond the predetermined threshold angle. The greater torque force at or beyond the predetermined threshold angle can be felt by the user, e.g., feel heavier, prior to the predetermined threshold angle and hence encourage the user to more slowly open the lid beyond the predetermined threshold angle, which can help prevent a collision between the lid and the surface from occurring at all, or help minimize collision damage to the lid and/or the surface due to slower movement of the lid during opening thereof. In another embodiment, the torque force can be less when the angle is at or beyond the predetermined threshold angle than the torque force needed to open the lid when the angle is less than the predetermined threshold angle. In other words, less force can be required to open the lid when the lid is beyond the predetermined threshold angle.

A person skilled in the art will appreciate that the devices and methods disclosed herein can be implemented using a computing device including a display. The term “computing device” as used herein refers to any of a variety of digital data processing devices, e.g., laptop or notebook computers, tablet computers, server computers, cell phones, PDAs, gaming systems, televisions, radios, portable music players, and the like. In an exemplary embodiment, the computing device is portable, although the computing device can be stationary. The term “display” as used herein refers to any of a variety of display devices, e.g., a liquid crystal display (LCD), a light-emitting diode (LED) screen, a cathode ray tube (CRT) screen, a touchscreen, a 3D screen, and the like. Additionally, the term “display” as used herein can refer to a display that is fixedly mounted in the same chassis or package as a base of a computing device, as well as to displays that are removably and replaceably mounted to the same chassis or package as a base of a computing device.

FIG. 3 illustrates one exemplary embodiment of a computing device 10 configured to provide a user cue during at least opening and closing of the device 10, and in an exemplary embodiment, during both opening and closing of the device 10. Although the device 10 in this illustrated embodiment includes a laptop or notebook computer, as mentioned above, other embodiments can include other types of computing devices. The device 10 can include any of a variety of software and/or hardware components. In addition, although an exemplary device 10 is depicted and described herein, a person skilled in the art will appreciate that this is for sake of generality and convenience. In other embodiments, the computing device may differ in architecture and operation from that shown and described with respect to any of the illustrated embodiments. Additional information on computer systems can be found in U.S. Patent Publication No. 2009/0150779 entitled “Method And Apparatus For Displaying Help Information” filed Dec. 5, 2008, which is hereby incorporated by reference in its entirety.

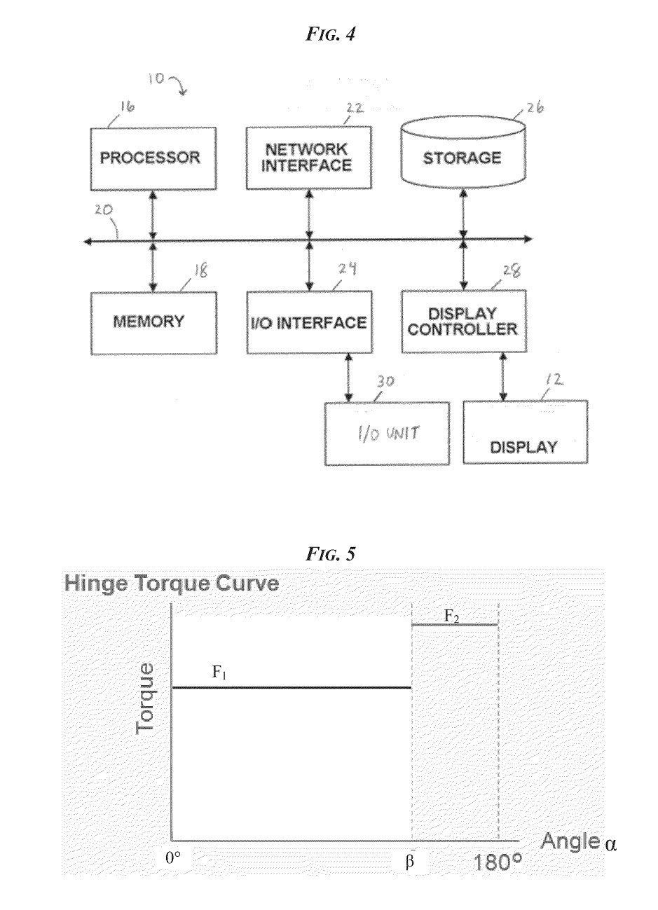

As shown in FIG. 4, the illustrated device 10 can include a processor 16 which controls the operation of the device 10, for example by executing an operating system (OS), a basic input/output system (BIOS), device drivers, application programs, and so forth. The processor 16 can include any type of microprocessor or central processing unit (CPU), including programmable general-purpose or special-purpose microprocessors and/or any one of a variety of proprietary or commercially-available single or multi-processor systems. The device 10 also includes a memory 18, which can provide temporary storage for code to be executed by the processor 16 or for data that is processed by the processor 16. The memory 18 can include read-only memory (ROM), flash memory, one or more varieties of random access memory (RAM), and/or a combination of memory technologies. The various elements of the device 10 can be coupled to a bus system 20. The illustrated bus system 20 is an abstraction that a person skilled in the art will appreciate represents any one or more separate physical busses, communication lines/interfaces, and/or multi-drop or point-to-point connections, connected by appropriate bridges, adapters, and/or controllers.

The device 10 can also include a network interface 22, an input/output (I/O) interface 24, a storage device 26, and a display controller 28. The network interface 22 can enable the device 10 to communicate with remote devices, e.g., other computing devices, over a network. The I/O interface 24 can facilitate communication between one or more I/O units 30. A person skilled in the art will appreciate that the device 10 can be configured to communicate with a variety of I/O units 30. Non-limiting examples of input units include a keyboard, a touch screen, a mouse, and a pointing device. Non-limiting examples of output units includes a speaker, a printer, a scanner, a removable memory, and the various other components of the device 10. The storage device 26 can include any conventional medium for storing data in a non-volatile and/or non-transient manner. The storage device 26 can thus hold data and/or instructions in a persistent state, i.e., the value is retained despite interruption of power to the device 10. The storage device 26 can include one or more hard disk drives, flash drives, universal serial bus (USB) drives, optical drives, various media disks or cards, and/or any combination thereof, and can be directly connected to the other components of the device 10 or remotely connected thereto, such as over a network. The display controller 28 can include a video processor and a video memory, and can generate images to be displayed on a display 12 in accordance with instructions received from the processor 16.

One or more software modules can be executed by the device 10 to facilitate human interaction with the device 10. These software modules can be part of a single program or one or more separate programs, and can be implemented in a variety of contexts, e.g., as part of an operating system, a device driver, a standalone application, and/or combinations thereof. A person skilled in the art will appreciate that any software functions being performed by a particular software module can also be performed by any other module or combination of modules.

The device 10 can be configured to open and close in a clamshell manner. A lid 32 of the device 10 and a base 34 of the device 10 can be configured to move between a closed configuration and an open configuration. The lid 32 can include the display 12 on an inner surface thereof, and the base 18 can include a keyboard (not shown) on an inner surface thereof. In this way, the display 12 and the keyboard 14 can be “hidden” when the device 10 is closed, which can help protect the display 12 and the keyboard 14 from damage when not in use.

Although the display 12 in this illustrated embodiment is on the inner surface of the lid 32, the display 12 can be on the lid 32, the base 34, and/or an external device (e.g., an external monitor, etc). The device 10 can include more than one display 12. As will be appreciated by a person skilled in the art, the lid 32 can include any number of elements in addition to the display 12. Non-limiting examples of elements that can be included in the lid 32 are one or more additional displays, a power control (e.g., a button, a switch, etc.), a port (e.g., a USB port, a FireWire port, an Ethernet port, etc.), a close or lock latch to help hold the device 10 closed, a parameter control (e.g., brightness, contrast, etc.), etc.

As mentioned above, the inner surface of the base 34 can have the keyboard thereon, e.g., on a surface that faces the lid 32 and the display 12 when the device 10 is closed. The base 34 can include any number of elements in addition to the keyboard. Non-limiting examples of elements that can be included in the base 34 are a pointing stick, a touchpad or trackpad, a media drive (e.g., a disk drive, a DVD drive, etc.), a port (e.g., a USB port, a FireWire port, an Ethernet port, etc.), a power control (e.g., a button, a switch, etc.), a WiFi network switch, a power cord outlet, a close or lock latch to help hold the device 10 closed, etc. In the illustrated embodiment, the base 34 includes the processor 16, the memory 18, the bus system 20, the network interface 22, the I/O interface 24, the storage device 26, and the display controller 28 illustrated in FIG. 4. In other embodiments, as will be appreciated by a person skilled in the art, any one or more of the processor 16, the memory 18, the bus system 20, the network interface 22, the I/O interface 24, the storage device 26 can be included in the lid 32 or can be located external to the lid 32 and the base 34, e.g., an external storage device plugged into a USB port, etc.

As in the illustrated embodiment, the device 10 can include the lid 32 hingedly connected to the base 34 to allow the device 10 to be hingedly opened and closed, as will be appreciated by a person skilled in the art. As in the illustrated embodiment, the lid 32 can have a rectangular shape and include opposed first and second longitudinal sides and opposed first and second latitudinal sides. Similarly, the base 34 can have a rectangular shape and include opposed first and second longitudinal sides and opposed first and second latitudinal sides. The first longitudinal side of the lid 32 and the first longitudinal side of the base 34 can be hingedly connected together to allow the device 10 to be opened and closed. Although in the illustrated embodiment the longitudinal sides of the lid 32 have a greater length than the latitudinal sides of the lid 32, and the longitudinal sides of the base 34 have a greater length than the latitudinal sides of the base 34, the lid 32 and/or the base 34 can have latitudinal sides having greater lengths than its longitudinal sides.

The device 10 is shown in FIG. 3 in the open configuration, with the lid 32 in darker shading showing the lid 32 and the base 34 in a fully open configuration and with the lid 32 in lighter shading showing the lid 32 and the base 34 in a partially open configuration. The device 10 includes a dropdown hinge mechanism, discussed further below, in which the lid 32 is configured to “drop down” below an inner surface of the base 34 when the device 10 is at least partially open, as shown in FIG. 3 with the lid 32 dropped down below the inner surface of the base 34 in the partially open configuration and in the fully open configuration. An angle α between the lid 32 and the base 34 in the closed configuration is about 0°. A person skilled in the art will appreciate that the lid 32 and the base 34 can be configured to be positioned at about 0° with respect to one another in the closed configuration with the angle α being equal to, slightly greater than, or slightly less than 0° due to one or more factors, such as manufacturing tolerances, loosening of movable parts caused by extensive use, etc. The lid 32 and the base 34 in the fully open configuration are at the angle α of about 180° with respect to one another. A person skilled in the art will appreciate that the lid 32 and the base 34 can be configured to be positioned at about 180° with respect to one another in the fully open configuration with the angle α being equal to, slightly greater than, or slightly less than 180° due to one or more factors, such as manufacturing tolerances, loosening of movable parts caused by extensive use, etc. The angle α between the lid 32 and the base 34 when the lid 32 and the base 34 are in the partially open configuration is greater than about 0° and less than the angle α when the lid 32 and the base 34 are in the fully open configuration, e.g., less than about 180°. In other words, the angle α between the lid 32 and the base 34 when the lid 32 and the base 34 are in the open configuration can be any positive degree value greater than about 0° and up to and including about 180°, with the lid 32 and the base 34 in the partially open configuration having any positive degree value greater than about 0° and less than about 180°.

In FIG. 3, the lid 32 and the base 34 are illustrated in the partially open configuration at a threshold angle β, e.g., with α equaling β. A torque force to move the lid 32 and the base 34 relative to one another can be different depending on whether the angle α between the lid 32 and the base 34 is less than the threshold angle β or is equal to or greater than the threshold angle β. FIG. 3 indicates the angle α being equal to or greater than the threshold angle β with reference α₂. The threshold angle β can have a variety of values. The threshold angle β can be any positive degree value greater than about 0° and less than about 180°. In an exemplary embodiment, the threshold angle β can have a positive degree value that is less than the angle α at which the lid 32 will collide with a surface on which the base 34 is resting. Although the base 34 is typically the portion of the device 10 resting on the surface, during unconventional use of the device 10, the lid 32 can be resting on the surface, as will be appreciated by a person skilled in the art. The change in the torque force when the angle α meets or exceeds the threshold angle β can thus encourage a user manually opening the lid 32 and the base 34 to stop the opening motion before the lid 32 collides with the surface, or, unconventionally, the base 34 collides with the surface. The lid 32 (or, unconventionally, the base 34) traditionally does not collide with the surface on which the device 10 is resting until the lid 32 and the base 34 are more than 75% open. The threshold angle β can therefore be about 75% of a maximum positive degree value of the angle α to allow the torque force change to occur prior to a chance of a collision between the device 10 and the surface on which the device 10 is resting. In other words, the threshold angle β can be about 75% of the angle α when the lid 32 and the base 34 are in the fully open configuration. The threshold angle β can thus be about 75% of 180°, e.g., about 135°.

The lid 32 and the base 34 can be configured to be positioned relative to one another at a first torque force F₁ when the angle α between the lid 32 and the base 34 is less than the threshold angle β, and be configured to be positioned relative to one another at a second, different torque force F₂ when the angle α is equal to or greater than the threshold angle β. In other words, the device 10 can have one torque force, e.g., the first torque force F₁, to move the device 10 between the closed configuration and a partially open configuration in which the lid 32 and the base 34 are at the angle β relative to one another, and the device 10 can have another torque force, e.g., the second torque force F₂, to move the device 10 between the partially open configuration and the fully open configuration. The change between the first torque force F₁ and the second torque force F₂ can be automatic, e.g., occur without user instruction other than the user manually opening/closing the device 10, regardless of whether the lid 32 and the base 34 are being moved toward the fully open position or being moved from toward the closed position.

In an exemplary embodiment, the second torque force F₂ can be greater than the first torque force F₁. In other words, the torque force to open the lid 32 and the base 34 can be greater at or above the threshold angle β. In this way, the device 10 can be configured to encourage a user manually opening the device 10 to more slowly open the device 10 after the lid 32 and the base 34 reach the threshold angle β because more force is required to open the device 10 after reaching the threshold angle β. Users will likely stop opening the device 10 at or shortly after the lid 32 and the base 34 reach the threshold angle β due to the force change from one force to another, higher force. The second torque force F₂ can be greater than the first torque force F₁ by any amount. In an exemplary embodiment, the second torque force F₂ can be greater than the first torque force F₁ by an amount configured to be palpably felt by a user manually opening/closing the device 10, such as the second torque force F₂ being about one and a half times greater than the first torque force F₁. The second torque force F₂ being about one and a half times greater than the first torque force F₁ can allow the device 10 to be opened/closed at the second torque force F₂ without undue strain while still allowing the torque force change to be noticeably palpable to the user. In another embodiment, the first torque force F₁ can be greater than the second torque force F₂, which can encourage a user manually opening/closing the device 10 to slowly open/close the device 10 and possibly not even open the device 10 as far as the threshold angle β.

The change from the first torque force F₁ to the second torque force F₂ can be configured to be palpably felt by a user manually opening the device 10. In other words, the first and second torque forces F₁, F₂ can be configured to be palpably felt by the user during the user's manual positioning of the lid 32 and the base 34 relative to one another so as to allow the user to palpably feel passage of the lid 32 and the base 34 through the threshold angle β. The device 10 can therefore be configured to provide a cue to the user as to when to stop opening the device 10, which can, as discussed above, help prevent the lid 32 (or, unconventionally, the base 34) from colliding with a surface on which the device 10 is resting. In the embodiment in which the second torque force F₂ is greater than the first torque force F₁, if the user continues opening the lid 32 and the base 34 after the cue, and a collision with the surface on which the device 10 is resting occurs, the greater second torque force F₂ can result in slower, less forceful opening of the device 10 and, hence, less of a collision force and less damage to the device 10 and/or the surface than if the device 10 was being opened at the first torque force F₁.

The cue can be silent and non-disruptive, as the transition between the first torque force F₁ and the second torque force F₂ can be palpable to a user manually positioning the lid 32 and the base 34 without any accompanying noise caused by the torque force change. Additionally, the device 10 can be configured to provide a sound cue when the angle α between the lid 32 and the base 34 reaches the threshold angle β. The sound cue can be electronic, such as by triggering the processor 16 to cause a sound, such as a beep, click, etc. to be played through a speaker or other audio output unit 30 of the device 10, as will be appreciated by a person skilled in the art. The processor 16 can be triggered in a variety of ways, as will be appreciated by a person skilled in the art, such as by a sensor (not shown) attached to one of the lid 32 and the base 34 moving a certain distance. Alternatively or additionally, the sound can be mechanical, such as by the lid 32 having a protrusion extending therefrom that is configured to pass through a movable flap attached to the base 34 so as to produce a mechanical sound when the protrusion passes through the flap, similar to a pin plucking a comb tooth in a music box mechanism. The mechanical sound can be produced in a variety of other ways, as will be appreciated by a person skilled in the art, such as by a protrusion being formed on the base 34 instead of the lid 32.

The first torque force F₁ can be configured to be uniform throughout movement of the lid 32 and the base 34 between about 0°, e.g., the closed configuration, and the threshold angle β, e.g., a partially open configuration, and/or the second torque force F₂ can be configured to be uniform through movement of the lid 32 and the base 34 between the threshold angle β, e.g., a partially open configuration, and about 180°, e.g., the fully open configuration. A person skilled in the art will appreciate that a torque force can have minor variations due to various factors, such as manufacturing tolerances, and still be a uniform torque force that is generally constant or steady.

In an exemplary embodiment, the first and second torque forces F₁, F₂ can each be uniform, which can help facilitate indication of passage through the threshold angle β because the torque force can be configured to only change once throughout movement of the lid 32 and the base 34 between the closed configuration and the fully open configuration. In other words, passage of the lid 32 and the base 34 through the threshold angle β can be more reliably palpably felt because the lid 32 and the base 34 can be configured to be movable at only those two torque forces F₁, F₂. FIG. 5 illustrates an embodiment of a torque force versus angle α graph in which the first torque force F₁ is uniform between about 0° and the threshold angle β, and the second torque force F₂ is uniform between the threshold angle β and about 180°.

In another embodiment, the first torque force F₁ can be variable, and the second torque force F₂ can be uniform, which can help facilitate indication of passage through the threshold angle β because the torque force can be configured to only be uniform when the lid 32 (or, unconventionally, the base 34) is near collision with a surface on which the device 10 is resting. By a previously variable torque force becoming uniform, the second torque force F2 being uniform can palpably cue a user manually opening/closing the device 10. FIG. 6 illustrates an embodiment of a torque force versus angle α graph in which the first torque force F₁ is variable between about 0° and the threshold angle β, and the second torque force F₂ is uniform between the threshold angle β and about 180°. The first torque force F₁ can vary in any number of ways; the variability of the first torque force F₁ in FIG. 6 is a non-limiting example. In an exemplary embodiment in which the first torque force F₁ is variable, the first torque force F₁ can be configured to ramp up, e.g., gradually increase, from when the angle θ is at a warning angle θ, which is less than the threshold angle β, to when the angle θ is at the threshold angle β, as shown in FIG. 6. By ramping up as the angle α approaches the threshold angle β, the first torque force F₁ can be configured to provide a warning cue to the user that the device 10 should stop being opened any further soon, if not at the present time. The warning angle θ can be non-zero, as in the embodiment illustrated in FIG. 6, which can allow the first torque force F₁ to provide lower resistance to opening/closing throughout at least a portion of its range. In another embodiment, the warning angle θ can be about 0° such that the first torque force F₁ ramps up continuously from when the angle α is about 0° to when the angle α is the threshold angle β. Prior to the angle α reaching the warning angle θ, the first torque force F₁ can be uniform at least for a portion of angle α values immediately prior to reaching the warning angle θ, as also shown in FIG. 6, which can help facilitate cueing the user to stop opening the device 10, e.g., help cue the user of impending achievement of the threshold angle β.

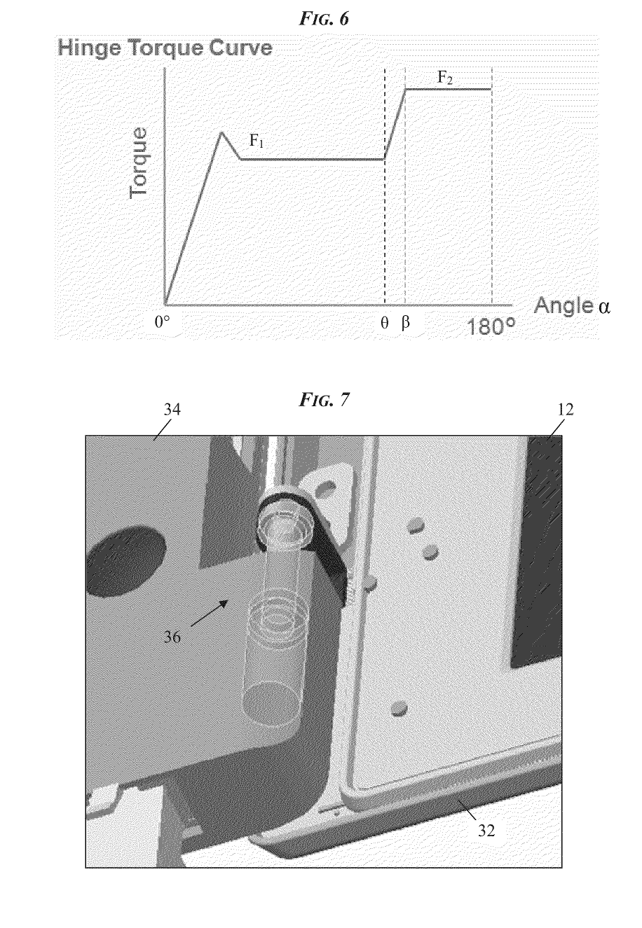

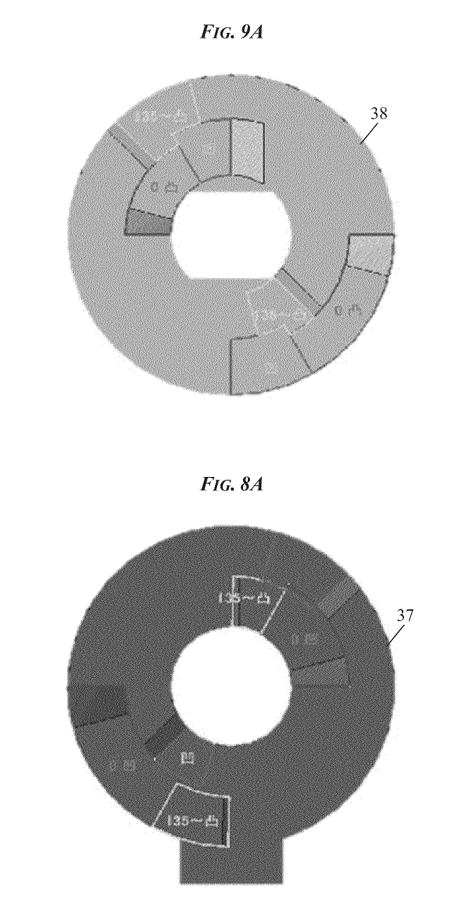

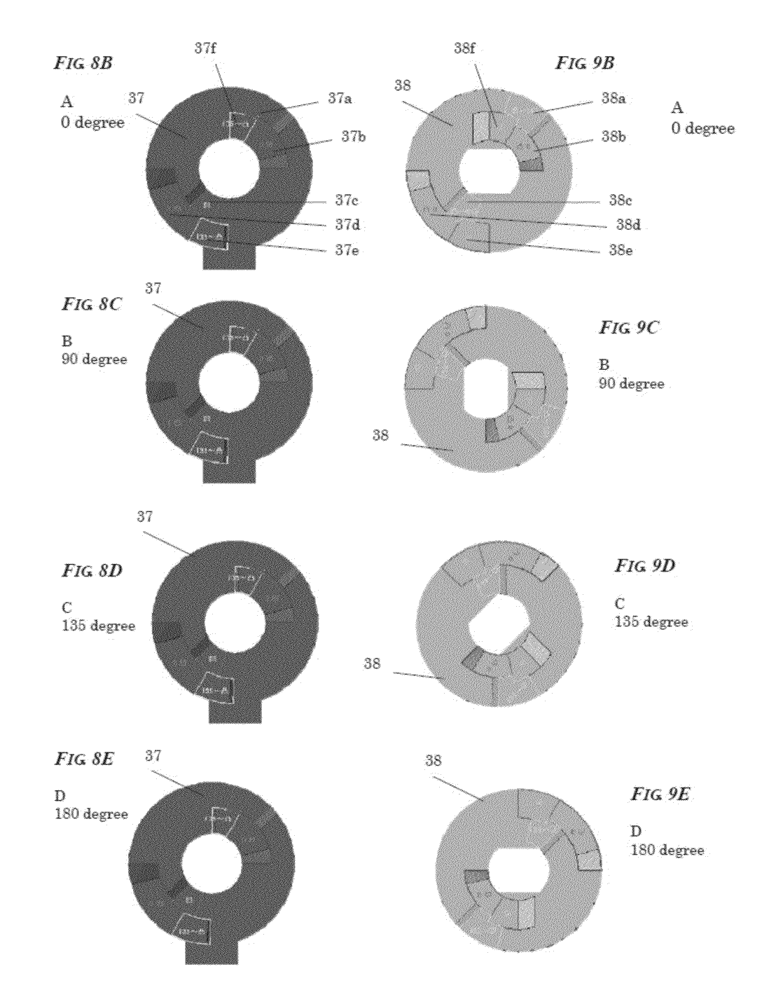

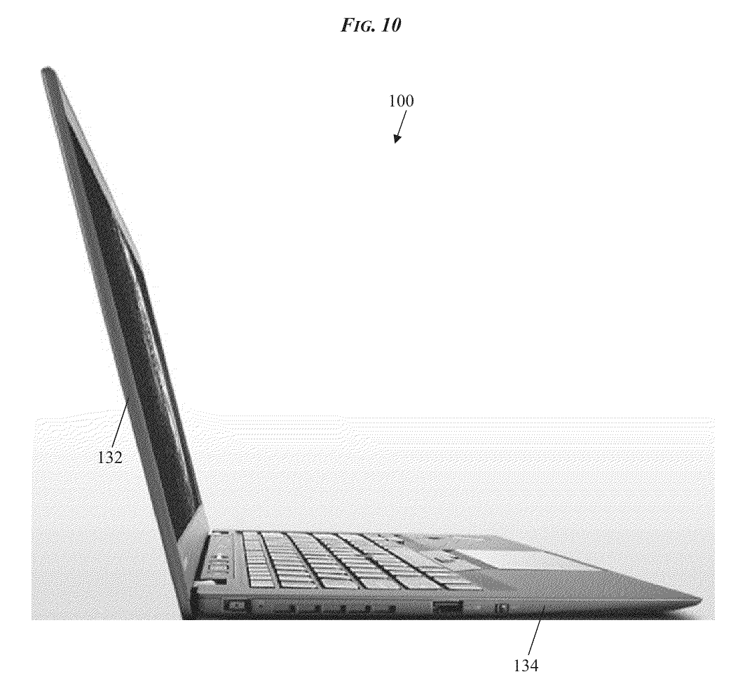

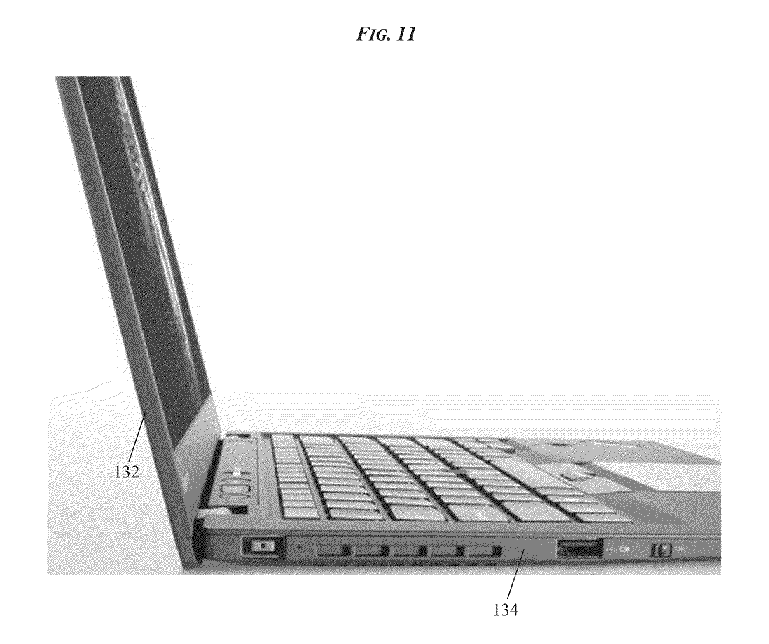

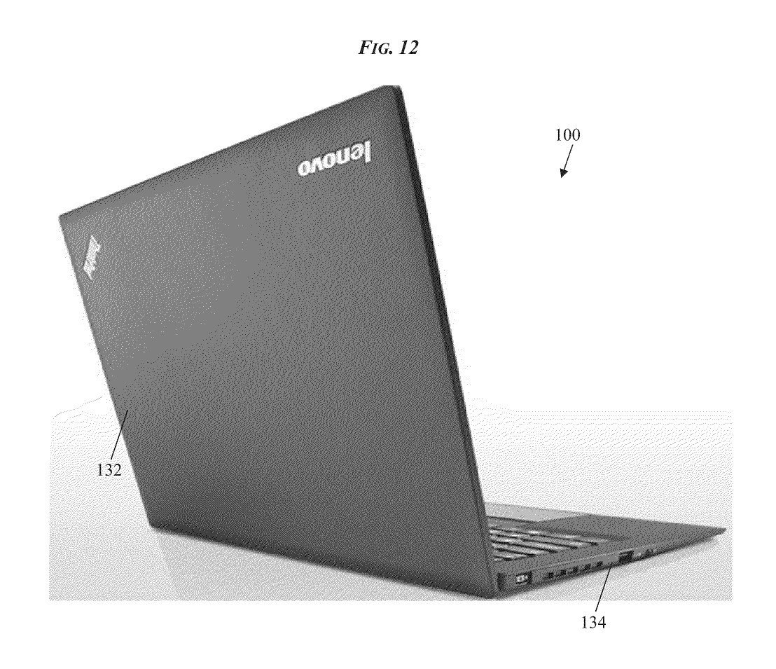

The device 10 can be configured to provide the first and second torque forces F₁, F₂ in a variety of ways. FIGS. 7-9 illustrate a hinge mechanism 36 of the device 10 configured to provide the threshold angle β as 135° and to provide the first and second torque forces F₁, F₂ illustrated in FIG. 6. The hinge mechanism 36 can be a “torque hinge,” which can include a pair of friction washers pushed against each other by a spring function. FIGS. 8A-9E illustrate an embodiment of a pair of friction washers 37, 38. FIG. 8A illustrates a rotating washer 38 coaxially coupled with the lid 32. The rotating washer 38 can be configured to rotates in accordance with the lid 32 opening/closing. The rotating washer 38 can have a non-round hole in its center, which can interlock with a non-round shaft, e.g., a rotating axle of the lid 32. FIG. 9A illustrates a stationary washer 37 geometrically fixed to the base 34. The stationary washer 37 can be configured to keep a stable position when the lid 32 opens or closes. The rotating washer 38 can be configured to slide along the non-round shaft and be pushed by spring washers toward the stationary washer 37. The rotating washer 38 and the stationary washer 37 can face each other and make friction, which results in the torque force.

The rotating washer 38 and the stationary washer 37 can each have bumps and dents on their faces, which can allow the torque force to vary with the angle of the lid 32. FIGS. 8B-9E illustrate how different torque forces can be made. In FIGS. 9B, 9C, 9D, and 9E, the image of the rotating washer 38 is reversed in left and right from FIG. 9A, for the ease of overlapping and comparing the position of the rotating washer 38 and the stationary washer 37. At (A) 0°, as shown in FIGS. 8B and 9B, first bump 38a, second bump 38b, third bump 38c, and fourth bump 38d of the rotating washer 38 fall, respectively, in first dent 37a, second dent 37b, third dent 37c, and fourth dent 37d of the stationary washer 37. First and second bumps 37e, 37f of the stationary washer 37 fall, respectively, in first and second dents 38e, 38f of the rotating washer 38. The rotating washer 38 can rotate clockwise when the lid 32 opens, e.g., when the lid 32 is moved from the closed position. When the rotating washer 38 starts to rotate, the bumps 38a, 38b, 38c, 38d of the rotating washer 38 climb up the slope of the dents 37a, 37b, 37c, 37d of the friction washer 37, respectively, so that torque force increases, and can cause a small force peak when the bumps 38a, 38b, 38c, 38d escapes the dents 37a, 37b, 37c, 37d. At (B) 90°, shown in FIGS. 8C and 9C, all of the rotating washer's bumps 38a, 38b, 38c, 38d can be sliding on a plain region of the friction washer 37, and the torque force can be stable at the first torque force F1. At (C) 135°, shown in FIGS. 8D and 9D, the first and third bump 38a, 38c of the rotating washer 38 can reach edges of the bumps 37e, 37f of the friction washer 37, respectively. From 135°, the first and third bump 38a, 38c of the rotating washer 38 and the bumps 37e, 37f of the friction washer 37 can be pushed to each other strongly by the spring washers which are compressed, such that the torque force can increase from the first torque force F1 to the second torque force F2. At (D) 180°, shown in FIGS. 8E and 9E, the first and third bump 38a, 38c of the rotating washer 38 can still be on the bumps 37e, 37f of the friction washer 37, respectively, so as to maintain the second torque force F2.

Elements discussed herein with reference to any computing device can generally be configured similar to like-named elements discussed herein.

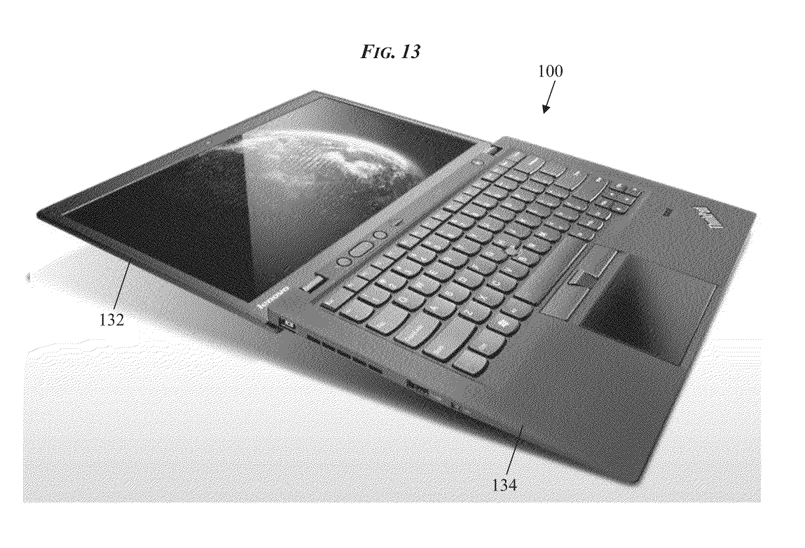

FIGS. 10-13 illustrate another embodiment of a computing device 100 configured to provide a user cue during at least opening and closing of the device 100, and in an exemplary embodiment, during both opening and closing of the device 100. The device 100 of FIGS. 10-13 includes a drop-down hinge mechanism in which a lid 132 of the device 100 is configured to “drop down” below a base 134 of the device 100. FIGS. 10-12 show the device 100 in a partially open configuration with the lid 132 and the base 134 at a threshold angle relative to one another. FIG. 13 shows the device 100 in a fully open configuration with the lid 132 and the base 134 at an angle of about 180° relative to one another.

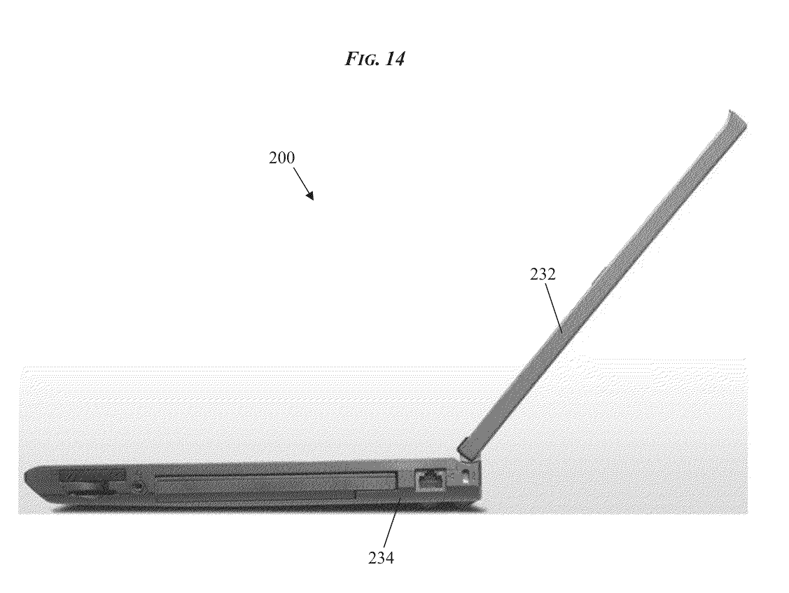

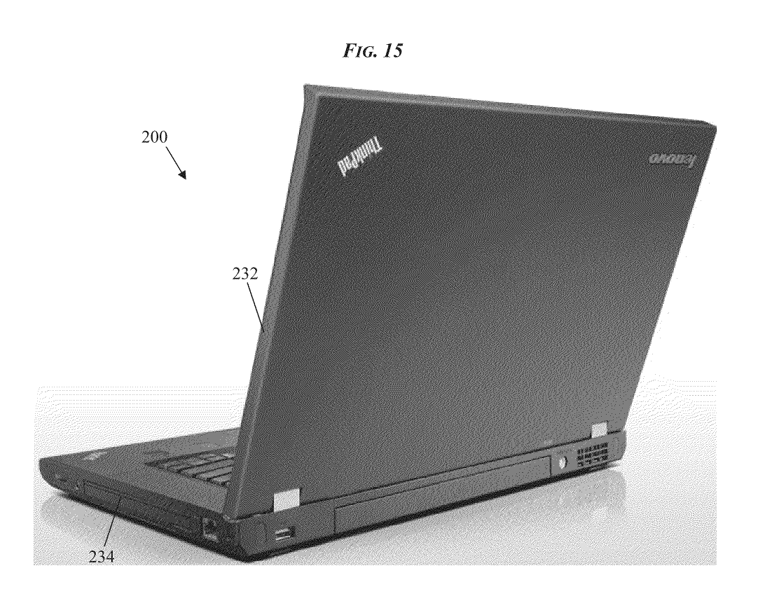

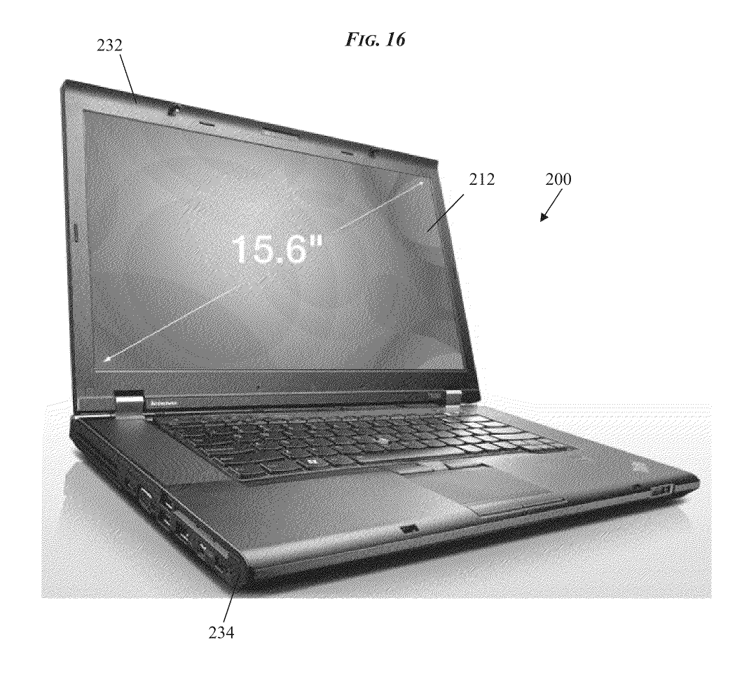

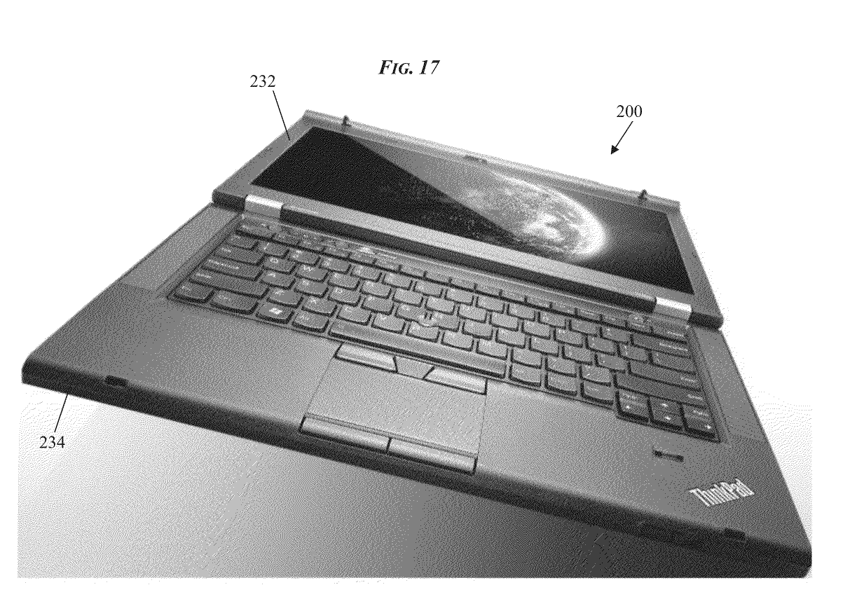

FIGS. 14-17 illustrate another embodiment of a computing device 200 configured to provide a user cue during at least opening and closing of the device 200, and in an exemplary embodiment, during both opening and closing of the device 200. The device 200 of FIGS. 14-17 includes a non-dropdown hinge mechanism in which a lid 232 of the device 200 remains above an inner surface of a base 234 of the device 200 when the device 200 is in a closed configuration and in an open configuration. FIGS. 14-16 show the device 200 in a partially open configuration with the lid 232 and the base 234 at a threshold angle relative to one another. FIG. 17 shows the device 200 in a fully open configuration with the lid 232 and the base 234 at an angle of about 180° relative to one another. FIG. 16 shows a display 212 on an inner surface of the lid 232 having a size of 15.6″, but the display 212 can have any size.

Although the invention has been described by reference to specific embodiments, a person skilled in the art will understand that numerous changes may be made within the spirit and scope of the inventive concepts described. A person skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A device, comprising:
a lid;
a base movably connected to the lid such that the lid and the base are configured to be positioned relative to one another at an angle up to 180°, a torque force to move the lid and the base relative to one another when the angle is at any positive degree value equal to or greater than a threshold positive degree value being greater than the torque force to move the lid and the base relative to one another when the angle is at any positive degree value less than the threshold positive degree value;
a display on at least one of the lid and the base; and
a processor coupled to at least one of the lid and the base, the processor being configured to cause data to be displayed on the display.

2. The device of claim 1, wherein the torque force to move the lid and the base relative to one another when the angle is at any positive degree value equal to or greater than the threshold positive degree value is a uniform torque force.

3. The device of claim 1, wherein the torque force to move the lid and the base relative to one another when the angle is at any positive degree value equal to or greater than the threshold positive degree value is about one and a half times the torque force to move the lid and the base relative to one another when the angle is at any positive degree value less than the threshold positive degree value.

4. The device of claim 1, wherein the lid and the base are at the threshold positive degree value relative to one another when the lid and the base are at about 75% of a maximum positive degree value of the angle.

5. The device of claim 1, wherein the threshold positive degree value is about 135°.

6. The device of claim 1, wherein the lid and the base are configured to be manually positioned relative to one another at the angle by a user, the torque force being configured to be palpably felt by the user during the user's manual positioning of the lid and the base relative to one another so as to allow the user to palpably feel passage of the lid and the base through the threshold positive degree value.

7. A device, comprising:
a lid;
a base hingedly connected to the lid such that the lid and the base are movable between a closed configuration and a fully open configuration, the lid and the base being movable at a first uniform torque force between the closed configuration and an intermediate position that is between the fully open configuration and the closed configuration, and the lid and the base being movable at a second uniform torque force between the intermediate position and the fully open configuration, the first uniform torque force being less than the second uniform torque force;
a display on at least one of the lid and the base; and
a processor coupled to at least one of the lid and the base, the processor being configured to cause data to be displayed on the display.

8. The device of claim 7, wherein the second uniform torque force is about one and a half times the first uniform torque force.

9. The device of claim 7, wherein the first uniform torque force is continuously uniform between the closed configuration and the intermediate position.

10. The device of claim 7, wherein the first uniform torque force is uniform for a partial amount of time between the closed configuration and the intermediate position and is variable for a second partial amount of time between the closed configuration and the intermediate position.

11. The device of claim 7, wherein the intermediate position is about 75% toward the fully open configuration from the closed configuration.

12. The device of claim 7, wherein an angle between the lid and the base when the lid and the base are in the closed configuration is about 0°, and the angle between the lid and the base when the lid and the base are in the intermediate position is about 135°.

13. The device of claim 12, wherein the angle between the lid and the base when the lid and the base are in the fully open configuration is about 180°.

14. The device of claim 7, wherein the lid and the base are configured to be manually hingedly moved relative to one another by a user, a change between the first uniform torque force and the second uniform torque force being configured to be palpably felt by the user during the user's manual movement of the lid and the base relative to one another.

15. A method, comprising:
providing a computing device including a lid and a base movably connected to the lid such that the lid and the base are configured to be positioned relative to one another at an angle up to 180°, a torque force to move the lid and the base relative to one another when the angle is at any positive degree value greater than a threshold positive degree value being greater than the torque force to move the lid and the base relative to one another when the angle is at any positive degree value less than the threshold positive degree value.

16. The method of claim 15, wherein the torque force to move the lid and the base relative to one another when the angle is at any positive degree value greater than the threshold positive degree value is a uniform torque force.

17. The method of claim 15, wherein the torque force to move the lid and the base relative to one another when the angle is at any positive degree value equal to or greater than the threshold positive degree value is about one and a half times the torque force to move the lid and the base relative to one another when the angle is at any positive degree value less than the threshold positive degree value.

18. The method of claim 15, wherein the lid and the base are at the threshold positive degree value relative to one another when the lid and the base are at about 75% of a maximum positive degree value of the angle.

19. The method of claim 15, wherein the threshold positive degree value is about 135°.

20. The method of claim 15, further comprising manually positioning the lid and the base relative to one another at the angle, passage of the lid and the base through the threshold positive degree value being palpable as the lid and the base pass through the threshold positive degree value.
